(19) United States
(12) Patent Application Publication
(10) Pub. No.: US 2014/0270842 A1
(43) Pub. Date: Sep. 18, 2014

(54) Image Forming Apparatus

(71) Applicant: Wazana Brothers International, Inc. d/b/a/ Micro Solutions Enerprises, Van Nuys, CA (US)

(72) Inventor: Jesus Gonzalez, Van Nuys, CA (US)

(73) Assignee: Wazana Brothers International, Inc. d/b/a/ Micro Solutions Enterprises, Van Nuys, CA (US)

(21) Appl. No.: 14/214,461

(22) Filed: Mar. 14, 2014

Related U.S. Application Data
(60) Provisional application No. 61/785,443, filed on Mar. 14, 2013.

(51) Int. Cl. G03G 15/08

(52) U.S. Cl. CPC G03G 15/0898
USPC 399/103; 399/104

(57) ABSTRACT

A method presently disclosed provides a housing configured to accommodate a roller, configured to accommodate a toner, and configured to accommodate at least one magnetic seal member, wherein the at least one magnetic member is configured to minimize leakage of the toner between the roller and the housing and couples at least one non-magnetic seal member with the housing, wherein the at least one non-magnetic seal member is configured to minimize leakage of the toner between the housing and the roller.

### CROSS REFERENCE TO RELATED APPLICATIONS

This application claims the benefit of U.S. Provisional Application No. 61/785,443, filed on Mar. 14, 2013, which is incorporated herein by reference in its entirety.

### FIELD

The present invention relates generally to the field of toner cartridges.

### BACKGROUND

Toner cartridges for laser printers are well known in the art. Generally, a cartridge will include sufficient toner for a large number of prints, such as 10,000 or 25,000, packaged in a housing which also contains those printing components that require periodic replacement, such as a photosensitive drum, magnetic and charging rollers, a regulating blade and a cleaning blade. The printing components and housing typically have a usable life, if properly cleaned and maintained, that greatly exceeds the number of prints for which toner is provided. Hence, toner cartridges are often remanufactured with a new supply of toner.

Remanufactured toner cartridges are both cost effective for consumers and environmentally sound. Original Equipment Manufacturers (OEMs) of printing equipment often provide “recycling” programs that allow consumers to return empty toner cartridges; the returned cartridges are shredded to recover some of the raw materials. Remanufacturing, in contrast, directly reuses most of the components of the cartridges, thereby greatly reducing the amount of material ending up in landfills, and having a substantially smaller carbon footprint than recycling.

In a typical laser printer, a revolving photosensitive drum or belt having a surface capable of holding a localized static charge is charged to a uniform voltage; a modulated laser is then scanned across the surface to remove the charge from those areas which are intended to be blank in the final image. A layer of toner, in the form of a fine powder, is then applied to the belt or drum by a regulating blade; the toner adheres to those areas of the belt or drum that were discharged by the laser. The drum or belt then deposits the toner on a print medium (such as paper), and residual toner is wiped off the drum or belt by a cleaning blade.

A challenge faced by toner cartridge remanufacturers is variability among components available for use in remanufactured cartridges. Components may be of varying ages, minor engineering changes may have been made between production runs of a cartridge, or it may be necessary to use a combination of refurbished parts and new replacement parts.

The toner used in a remanufactured cartridge can also vary from that used by the OEM. While the remanufacturer will typically specify a toner that essentially matches the important performance characteristics of the OEM toner, and therefore provides a print quality close to the OEM toner, toner formulations are complex, involving many production steps and constituents. Some aspects of the OEM toner may be covered by patents, or different toner additives may be used due to availability or cost.

The OEM has the ability to fine tune the printing system, including the components in the cartridge, the toner, and the operation of the printer itself, including various initialization and cleaning operations. The OEM may, for example, formulate the materials of the photosensitive drum, the cleaning blade, and PCR such that the printing system functions reliably for the number of prints provided by the original supply of toner, but not necessarily for the extended life of a refilled cartridge. The OEM may also utilize coatings or treatments on the components which are substantially degraded due to wear by the end of the original life of the cartridge.

The wear on components and differences in toner formulations may result in prints produced over time with a remanufactured cartridge exhibiting print defects.

To keep the cost of remanufactured cartridges low, it is important that any modifications to the cartridge be done in a manner that requires as few steps as possible and that don't require significant changes to the cartridge itself.

There is thus a need for a toner cartridges which do not exhibit print defects, and/or for methods allowing simple retrofitting of cartridges.

### BRIEF DESCRIPTION OF THE FIGURES

FIG. 1 depicts a disassembled perspective view of a cartridge frame body.

FIG. 2 depicts a perspective view showing state of some of the parts before they are assembled.

FIGS. 3 depict a perspective view of a magnetic seal.

FIG. 4 depicts a perspective view showing a developing bearing frame body and a developing frame body before they are assembled.

FIGS. 5 is a perspective view showing a developing roller and a magnetic seal.

FIG. 6A depicts a sectional view of the developing roller and the magnetic seal taken along an XVII-XVII line in FIG. 5.

FIG. 6B depicts is a macrograph of the part of 6B in FIG. 6A.

FIGS. 7A-F depict exemplary replacement seals according to the present application.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

In one embodiment, a perspective view showing the frame configuration of the cartridge 15 before it is assembled is shown in FIG. 1. The cartridge 15 is chiefly composed of three frame bodies: a cleaning frame body 13 in which the photosensitive body drum 11, the charging roller 12 and the cleaning blade 14 are integrally incorporated; a developing frame body 17 in which the developing roller 18 and the developing blade (not shown) are integrally supported; and the toner containing frame body 16 containing toner therein. Moreover, side covers 19 and 20 for supporting the three frame bodies 13, 17 and 16 integrally fix them on both the side faces of them to constitute the cartridge 15.

The cleaning frame body 13 fixes the cleaning blade 14 with machine screws or the like thereto, and supports the charging roller 12 rotatably at the core metal portions on both end portions of the charging roller 12 with bearing members (not shown) being put between the cleaning frame body 13 and the charging roller 12. Moreover, the cleaning frame body 13 rotatably supports the photosensitive body drum 11 at flange portions 11a and 11b on both end portions of the photosensitive body drum 11 with bearing members 22 and 23 being put between the cleaning frame body 13 and the photosensitive body drum 11. The toner containing frame body 16 contains toner (not shown) in its inside together with toner carrying members.

The developing roller 18 including a magnet roller 18a, the developing blade 26 and a magnetic seal 50 (both shown in FIG. 2) are disposed in the developing frame body 17. One side end of the magnet roller 18a is supported by a projecting portion 17e being a developing roller bearing of the developing frame body 17 and the other side end thereof is supported by the developing frame body 17, and the magnet roller 18a keeps a gap with the developing roller 18. The developing roller 18 is configured to perform the electric power supply thereto through an electric contact point disposed in the inside of the developing roller 18. Moreover, a spacer roller 53 (shown in FIG. 2) for keeping the interval from the photosensitive body drum 11 constant is provided on the developing roller 18.

The developing frame body 17 is supported by the cleaning frame body 13 swingably around a suspension hole 17d formed on one side face side of the developing roller 18 such that the center of the developing roller 18 goes toward the center of the photosensitive body drum 11.

Moreover, the cartridge 15 is configured to pressurize the projecting portion 17e, which is fixed on a central axis line of the developing roller 18 in the lengthwise direction thereof on the other side face side of the developing frame body 17, toward the center of the photosensitive body drum 11. The projecting portion 17e is configured to be inserted into a groove 19e (an elongated hole in the shape of a straight line substantially parallel in the center direction of the photosensitive body drum 11 in the present embodiment) formed on the side cover 19 in the state movable to the center direction of the photosensitive body drum 11. Moreover, an elastic member (not shown) is disposed in the inside of the groove 19e such that the elastic body pressurizes the projecting portion 17e to bias the developing roller 18 along the photosensitive body drum 11. On the other hand, the groove 19e also has the role of a locating hole for regulating the moving direction of the developing roller 18.

When a driving force works on the cartridge 15, not shown gears, which are respectively provided on the photosensitive body drum 11 and the developing roller 18, are designed to receive a force respectively in the direction of interlocking with each other around the suspension hole 17d lest the forces should work in the direction to separate the photosensitive body drum 11 and the developing roller 18 from each other. Moreover, the elastic member provided in the groove 19e also pressurizes the developing roller 18 toward the photosensitive body drum 11 always.

The side cover 19 on one side has a size covering a principal section of the cartridge 15. The side cover 19 is disposed on one end of the cartridge 15 in the lengthwise direction. The side cover 19 integrally supports the cleaning frame body 13 and the toner containing frame body 16 by fixing them thereto respectively. A hole portion 19a in the side cover 19 is located on the same axis as that of the center of the photosensitive body drum 11. At this time, if the location of the side cover 19 is performed by the use of the bearing member 22, the location can be determined highly precisely. Moreover, a locating portion 19b formed at a position distant from the photosensitive body drum 11 as far as possible locates the position of side cover 19 in the rotational direction thereof together with a locating portion 13b formed on a side face of the cleaning frame body 13, and the side cover 19 and the cleaning frame body 13 are fixed to each other with several machine screws. Furthermore, the toner containing frame body 16 forms locating portions 16a and 16b on its one end face. The toner containing frame body 16 is located to the side cover 19 by means of the locating portions 16a and 16b and locating portions 19c and 19d disposed on the side cover 19. The toner containing frame body 16 is fixed to the side cover 19 with several machine screws. The side cover 20 on the other side is similarly configured.

Moreover, opening portions 16c and 17a are respectively formed in the toner containing frame bode 16 and the developing frame body 17 for the supply of toner from the toner containing frame body 16 to the developing roller 18. The opening portions 17a and 16c in the developing frame body 17 and the toner containing frame body 16 are connected through a seal member 21. Moreover, the toner containing frame body 16 is located by the side covers 19 and 20, the developing frame body 17 is located by the cleaning frame body 13. There is consequently the possibility that distortion is produced in either of the developing frame body 17 and the toner containing frame body 16 owing to dimension errors between them. Accordingly, the seal member 21 is made from a flexible material. In such a configuration, if toner increases in the cartridge 15, the load owing to the increased toner is imposed on the side covers 19 and 20, and no loads are imposed on the developing roller 18. Consequently, no surplus loads are imposed on the photosensitive body drum 11, and stable images can be obtained. Moreover, because the three frame bodies 13, 17 and 16 are connected to the side covers 19 and 20 on their side faces, the locations of the respective frame bodies 13, 17 and 16 can be determined by means of only the side covers 19 and 20. Consequently, the frame bodies 13, 17 and 16 can precisely be connected to each other.

In one embodiment, a perspective view showing a state of some of the parts of the developing frame body 17 before they are assembled is shown in FIG. 2.

As shown in FIG. 2, the developing blade 26 is composed of a sheet metal 26a and a polyurethane rubber 26b fixed on the sheet metal 26a by hot melt adhering or with a pressure sensitive adhesive double coated tape or the like. By the contact of the polyurethane rubber 26b with a generating line of the developing roller 18, the quantity of the toner on the peripheral surface of the developing roller 18 is regulated. Incidentally, a silicon rubber may be employed as the developing blade 26. Female screws 17g are provided on anti-climbing planes 17f formed in the developing frame body 17 as blade fitting portions, and dowels (not shown) for location are formed at positions near to the centers of the anti-climbing planes 17f a little. Accordingly, fitting holes 26d formed in the sheet metal 26a are fitted to the dowels (not shown) each other. After that, machine screws 57 are screwed into the female screws 17g through tapped holes 26c to fix the sheet metal 26a to the anti-climbing planes 17f. Thus, the position of the leading edge of the polyurethane rubber 26b is determined, and then the touching pressure of the polyurethane rubber 26b to the developing roller 18 is determined. Consequently, the distance from the leading edge of the polyurethane rubber 26b to the touching position is determined, and the development condition is determined. Moreover, one end of the sheet metal 26a of the developing blade 26 is bent by the angle of about 90 degrees to form a bent portion 26e for the heightening of the rigidity of the sheet metal 26a in order that the polyurethane rubber 26b is touched to the developing roller 18 uniformly in the lengthwise direction of the developing roller 18.

Incidentally, an elastic seal member 51, which is made from an urethane-foam or the like is formed in a shape of substantially a letter U, is stuck to the developing frame body 17 along its elastic seal seat surface 17h (see FIG. 2) at the upper part of the opening portion 17a in the lengthwise direction and its seat surfaces 17j in the widthwise direction for the prevention of the leakage of toner to the outside. A first straight line portion 51c of the elastic seal member 51 is stuck to the seat surface 17h of the developing frame body 17, and second straight line portions 51a of the seal member 51 are stuck to the seat surfaces 17j. The elastic seal member 51 is put between the developing frame body 17 and the developing blade 26 to be pinched out by them, and thereby the leakage of toner is prevented. Lug portions 51b are formed on the elastic seal member 51 at both end portions thereof to project from the end portions in the lengthwise direction of the seal member 51 by several millimeters. The lug portions 51b perform the role of locating the magnetic seal 50, which will be described later.

As shown in FIG. 2, the magnetic seals 50 are attached to grooves 17k formed on the surfaces adjoining (at the insides of arc surfaces 171 in the lengthwise direction of the developing roller 18) to the arc surfaces 171 and flat surfaces continuing upward from the arc surfaces 171 along the peripheral direction of the developing roller 18 at both end portions of the opening portion 17a in the lengthwise direction of the developing roller 18. The magnetic seals 50 will be described later in detail.

The developing roller 18 is a cylindrical member made of a metal material of aluminum, stainless steel or the like. A surface treatment such as carbon coating, abrasive blasting or the like is performed to the surface of the developing roller 18 for the heightening of the electrification characteristic of developer. Only the carbon coating is performed in the present embodiment.

Sleeve flanges (only one end portion of them is shown in FIG. 2) 18s, which are stepped cylindrical members made of a metal material of aluminum, stainless steel or the like, are force-fitted into both end portions of the developing roller 18. Each of the sleeve flanges 18s is coaxial with the developing roller 18, and is composed of a first cylindrical portion 18b and a second cylindrical portion 18c, the outer diameters of which are smaller in the order. The first cylindrical portion 18b is provided with a spacer roller 53 being a ring-shaped distance regulating member for regulating the opposed distance between the developing roller 18 and the photosensitive body drum 11. The space roller 53 is made from an insulating material such as polycetal or the like. A developing bearing frame body 55 (its especially enlarged perspective view seen from the reverse side is shown in FIG. 4) for supporting the developing roller 18 rotatably and locating it to the developing frame body 17 is disposed around the second cylindrical portion 18c. Moreover, two flat surfaces 18d are for at the tip portion of the second cylindrical portion 18c, and a developing roller gear 54 made from a synthetic resin is fitted to the cylindrical portion 18c having the flat surfaces 18d. The developing roller gear 54 is driven by a helical drum gear (not shown) provided at an edge portion of the photosensitive body drum 11 to rotate the developing roller 18. The helical teeth of the drum gear are twisted such that the thrust thereof in the axial direction thereof works in the lengthwise direction of the developing roller 18. Moreover, a magnet roller (designated by a reference numeral 18a in FIG. 1) for making toner adhere to the peripheral surface of the developing roller 18 is built in the developing roller 18. Because the sleeve flange on the other end portion of the developing roller 18 has a similar configuration, the descriptions thereof is here omitted. The developing bearing frame body 55 is made from a resin material producing a good slidable property, and is shaped to be a flat plate. At approximately the center of the flat plate portion, a cylindrical bearing portion 55a is formed. The bearing portion 55a fits to the second cylindrical portion 18c of the sleeve flange 18s, and thereby the developing roller 18 slides therein while rotating. Moreover, a dowel 55c including a first step portion 55d, and a second step portion 55e at its end portion, both being for locating the developing bearing frame body 55 against the developing frame body 17, is formed on the surface 55g of the flat plate portion of the developing bearing frame body 55 substantially parallel to the bearing portion 55a. The dowel 55c performs the role of locating the developing bearing frame body 55 against the developing frame body 17. The first step portion 55d and the second step portion 55e, both being coaxial with the dowel 55c at the end portion of the dowel 55c, is used for the location of the magnetic seal 50, which will be described later. Moreover, on the same surface 55g, tapped holes 55b for the fixation of the developing bearing frame body 55 to the developing frame body 17 with machine screws 56 or the like, and a dowel 55f for the location of the developing bearing frame body 55 to the developing frame body 17 are formed. The dowel 55c of the developing bearing frame body 55 is fitted into a location hole 17c (shown in FIG. 4) formed in the developing frame body 17, and the dowel 55f is fitted into a fitting elongated hole 17o formed in the developing frame body 17, and further the surface 55g of the developing bearing frame body 55 is touched to a surface 17p (shown in FIG. 4) of the developing frame body 17. Then, the machine screws 56 are screwed into female screws 17q and 17r (both shown in FIG. 4) formed on the developing frame body 17 through the two tapped holes 55b, and the developing bearing frame body 55 is fixed to the developing frame body 17, Thereby, the positions of the developing blade 26 and the developing roller 18, both being fixed to the developing frame body 17, are surely determined, and stable images can be outputted.

Because the developing roller 18 slides in the bearing portion 55a. of the developing bearing frame body 55 mentioned above, the material of the developing bearing frame body 55 is preferably a comparatively high priced material—having a good sliding property (for example, a bearing material based on poly phenylene sulfide (PPS) or polyamide (PA)).

The magnetic seal 50 (shown in an especially enlarged figure in FIG. 3) is an injection-molded article. A magnet 50a being a component of the magnetic seal 50 includes Nd—Fe—B magnetic power with a nylon binder. A magnetic plate 50b being another component of the magnetic seal 50 is made from iron. The magnet 50a and the magnetic plate 50b are molded by the insert molding such that the magnetic plate 50b is embedded in the magnet 50a except for the remaining inner periphery and the outside side face of the magnet 50. However, the joining by an adhesive, the joining by a pressure sensitive adhesive double coated tape, or the attraction joining only by a magnetic three can similarly bring about the advantages that will be described later. Moreover, the gap between the developing roller 18 and the magnetic seal 50 is, for example, about 0.1 mm to 0.7 mm, and the magnetic flux density on the surface of the developing roller 18 owing to the magnetic force of the magnetic seal 50 in this case is, for example, about 1,000 Gs to 2,000 Gs. Then, as shown in FIG. 5, in the state such that two magnetic seals 50 are fixed to the developing frame body 17, the magnets 50a of the two magnetic seals 50 are located to be opposed to each other.

By the disposition of the two magnetic seals 50 in the way described above, the lines of magnetic forces 75 (shown in FIG. 6B) of each of the magnetic seals 50 are formed between the magnet 50a and the magnetic plate 50b to enter into the magnetic plate 50b having a higher permeability as shown in FIG. 6B, which is a macrograph of the part of 6B in FIG. 6A. Consequently, no lines of magnetic forces expand to the outside of the width of the magnetic seal 50.

Consequently, no toner diffusing along the lines of magnetic forces 75 (shown in FIG. 6B) on the surface of the magnetic seal 50 exists on the outside of the magnetic plate 50b on the side of the magnetic plate 50b (or the outside of the opening portion 17a). The phenomenon such that toner is touched to the spacer roller 53 being a distance regulating member owing to the rotations of the developing roller 18 does not happen.

Consequently, the spacer roller 53 can be approached to the side face of the magnetic seal 50, and thereby naturally the cartridge 15 can be miniaturized.

Moreover, because the toner on the magnetic seal 50 does not diffuse to the outside of the opening portion 17a of the developing frame body 17 from the magnetic plate 50b, the toner can securely be held within a range where the magnetic force on the surface of the magnetic seal 50 is strong.

As shown in FIG. 3, both the magnet 50a and the magnetic plate 50b have a half arc portion 50e (or the half arc portion of the magnetic seal 50), the inner periphery side of which forms a gap g1 with the developing roller 18, and an end face portion 50e, which offsets to the side of the developing frame body 17 halfway on the half arc portion 50e to extend upward in a straight line from the upper part of he half arc portion 50e. The cross section of the magnet 50a is nearly a square, and the cross section of the magnet 50a combined with the magnetic plate 50b is a square. An arc-shaped bending portion 50h projects towards the outside in the radial direction from the outer periphery 50f of the magnet 50a, and the location hole 50d is exists at the center of the arc of the bending portion 50h. As shown in FIG. 3, the upper end of the magnetic plate 50b is fitted into the end face portion 50e, and the magnet 50a and the magnetic plate 50b form the same plane on the outside side face of the magnetic seal 50 in the lengthwise direction. As shown in FIG. 2, a groove 17k (17k1, 17k2 and 17k3) for the attachment of the magnetic seal 50 is formed from the anti-climbing plane 17f, to which the developing blade 26 is attached, to an adjoining position to the arc surface 171 along an end portion of the developing roller 18. The groove 17k is composed of an arc groove 17k1 along the arc of the arc surface 171 (see FIG. 2), a straight line groove 17k2 along the anti-climbing plane 17f in a vertical direction, and a location groove 17k3, in which the bending portion 50h (the inner periphery of which forms the location hole 50d) of the magnetic seal 50 is just fitted. These grooves 17k1, 17k2 and 17k3 are continuously formed. The location groove 17k3 is recessed from the base of the arc groove 17k1. The width of the groove 17k and the width of the magnetic seal 50 are formed to be the same. And, the magnetic seal 50 is fitted into the groove 17k. Thereby, the position of the magnetic seal 50 to the developing roller 18 in the lengthwise direction of the developing roller 18 is determined. Moreover, the depth of each portion of the groove 17k for the attachment of the magnetic seal 50 thereto is deeper than the thickness of each corresponding portion of the magnetic seal 50 by, for example, about 0.1 mm to 0.7 mm when the magnetic seal 50 is fitted into a predetermined position (the fitting will be described later). That is, the surface of the outer periphery 50f of the magnetic seal 50 keeps a gap (not shown) from the groove 17k of the developing frame body 17. For the prevention of the leakage of toner through the gap, a magnetic pole is disposed on the surface of the outer periphery 50f of the magnetic seal 50 as a magnetic pole is disposed on the surface opposed to the developing roller 18, and the leakage of toner to the outside can be prevented by the magnetic force caused by the magnetic pole. Moreover, the magnetic seal 50 may be configured such that the magnetic plate 50b is extended to the surface of the outer periphery 50f to prevent the leakage of the magnetic force to the outside likewise on the developing roller 18 side for heightening the effect of the magnetic force.

As shown in FIG. 2, the magnetic seals 50 are brought into the grooves 17k of the developing frame body 17 for the attachment of the magnetic seals 50 as indicated by an arrow D. Then, the half arc portions 50e of the magnetic seals 50 are fitted into the arc grooves 17k1, and the end face portions 50c are fitted into the straight line grooves 17k2. After that, the magnetic seals 50 are pushed into the arc grooves 17k1 and the straight line grooves 17k2 until the inner peripheral surfaces of the half arc portions 50e are at substantially the same heights as those of the arc surfaces 171. Next, the first straight line portion 51c of the elastic seal member 51 is stuck to the elastic seat surface 17h being the end face of a rib of the developing frame body 17 in the lengthwise direction, and the second straight line portions 51a are stuck to the seat surfaces 17j of the developing frame body 17. And further, the lug portions 51b are stuck to the end face portions 50c of the magnetic seal 50. At this time, because the heights of the elastic seal seat surface 17h and the magnetic seal 50 are different from each other, the elastic seal member 51 is not easy to stick. For making it easy to stick the elastic seal member 51, a tapered plane 50g (shown in FIG. 3) is formed. Moreover, the lug portions 51b and the second straight line portions 51a may be formed to be separate bodies in view of material allotting. As for the incorporation of the developing blade 26, as described above, the fitting holes 26d formed in the sheet metal 26a are fitted to the dowels (not shown) each other. After that, the machine screws 57 are screwed into the female screws 17g through the tapped holes 26c formed in the sheet metal 26a to fix the sheet metal 26a to the anti-climbing planes 17f. Next, the unit of the developing roller 18 is temporarily put in the developing frame body 17 to be coaxial with the half arc portions 50e of the magnetic seals 50. At this time, the developing roller 18 does not directly contact with the magnetic seals 50 owing to the repulsive force of the polyurethane rubber 26b of the developing blade 26, and consequently the surface of the developing roller 18 is not injured by the magnetic seals 50.

Furthermore, the developing bearing frame bodies 55 are assembled from both side face sides of the developing frame body 17 (though FIG. 2 shows one end side of the developing frame body 17, the other end side thereof is in the same configuration). That is, as described above by reference to FIG. 4, the dowels 55f are fitted into the fitting elongated holes 17o (shown in FIG. 4), and further the surfaces 55g of the developing bearing frame bodies 55 are touched to the surfaces 17p of the developing frame body 17. Then, the machine screws 56 are screwed into the female screws 17q and 17r formed on the surfaces 17p through the tapped holes 55b formed in the developing bearing frame bodies 55, and the developing bearing frame bodies 55 are fixed to the developing frame body 17. Thereby, the magnetic seals 50 are located around the first step portions 55d in the states of being able to tilt. The magnetic seals 50 receive moments around the first step portions 55d by forces biased by the repulsive force of the elastic seal member 51 lying between the magnetic seals 50 and the developing blade 26, and the lower end faces of the magnetic seals 50 are touched to the lower end faces 17k4 of the grooves 17k of the developing frame body 17.

In an effort to minimize leakage of toner between the magnetic seal(s) 50 and the developing roller 18, in some embodiments according to the present disclosure, one or both of the magnetic seal(s) 50 may be replaced with a flexible material 190, as shown in FIG. 7A. In some embodiments, the flexible material 190 comprises adhesive layer (not shown) covered by a protective layer 201 as shown in FIG. 7D. In some embodiments, the protective layer 201 is removed and the flexible material 190 (shown in FIG. 7D) is coupled with the grooves 17k. In another embodiment, the magnetic seal(s) 50 is installed above the flexible material 190. In another embodiment, the magnetic seal(s) 50 is installed in the grooves 17k and the flexible material 190 is coupled with the magnetic seal(s) 50. In another embodiment, the magnetic seal(s) 50 is installed in the grooves 17k and the flexible material 190 is installed adjacent with the magnetic seal(s) 50.

In some embodiments according to the present applications, one or both of the magnetic seal(s) 50 may be replaced with material 191 that is substantially shaped like the magnetic seal 50, as shown in FIG. 7B. In some embodiments, the material 191 comprises adhesive layer (not shown) covered by a protective layer 202 as shown in FIG. 7E. In some embodiments, the protective layer 202 is removed and the material 191 (shown in FIG. 7E) is coupled with the grooves 17k. In another embodiment, the magnetic seal(s) 50 is installed above the material 191. In another embodiment, the magnetic seal(s) 50 is installed in the grooves 17k and the material 191 is coupled with the magnetic seal(s) 50. In another embodiment, the magnetic seal(s) 50 is installed in the grooves 17k and the material 191 is installed adjacent with the magnetic seal(s) 50. In another embodiment according to the present applications, one or both of the magnetic seal(s) 50 may be replaced with material 195 that may comprise at least two materials 192 and 193 that are coupled together as shown in FIG. 7C. In some embodiments, the material 195 comprises adhesive layer (not shown) covered by a protective layer 203 as shown in FIG. 7F. In some embodiments, the protective layer 203 is removed and the material 195 (shown in FIG. 7F) is coupled with the grooves 17k. In another embodiment, the magnetic seal(s) 50 is installed above the material 195. In another embodiment, the magnetic seal(s) 50 is installed in the grooves 17k and the material 195 is coupled with the magnetic seal(s) 50. In another embodiment, the magnetic seal(s) 50 is installed in the grooves 17k and the material 195 is installed adjacent with the magnetic seal(s) 50.

Replacing the one or more magnetic seals 50 with the materials 190 or 191 or 195 provides tighter fit between the materials 190, 191, 195 and the developing roller 18. Combining the one or more magnetic seals 50 with the materials 190 or 191 or 195 also provides tighter fit between the magnetic seals 50 and the materials 190, 191, 195 and the developing roller 18.

In one embodiment according to the present application, the materials 190, 191 may be used to replace the magnetic seal(s) 50 during remanufacturing of the cartridge 15. In one embodiment, the material 192 may be Teflon felt and the material 193 may be foam.

The materials 190 and/or 191 may comprise plastic, polymeric material, woolen felt or PTFE pile, a foamed material such as polyurethane foam or sponge rubber, or Teflon felt disposed above a foamed material.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

What is claimed is:

1. A method comprising:
providing a housing configured to accommodate a roller, configured to accommodate a toner, and configured to accommodate at least one magnetic seal member, wherein the at least one magnetic member is configured to minimize leakage of the toner between the roller and the housing; and
coupling at least one non-magnetic seal member with the housing, wherein the at least one non-magnetic seal member is configured to minimize leakage of the toner between the housing and the roller.

2. The method of claim 1, wherein the at least one non-magnetic seal is in physical contact with the roller.

3. The method of claim 1, wherein the at least one non-magnetic seal comprises an adhesive layer.

4. The method of claim 1, wherein the at least one non-magnetic seal is positioned adjacent with the at least one magnetic seal.

5. The method of claim 1, wherein the at least one non-magnetic seal member comprises woolen felt, a PTFE pile, a plastic, a foamed material or Teflon felt disposed above a foamed material.

6. The method of claim 5, wherein the foamed material comprises a polyurethane foam or sponge rubber.

7. The method of claim 1, wherein the at least one non-magnetic seal member comprises flexible material.

8. The method of claim 1, wherein the at least one non-magnetic seal member is substantially same shape as the at least one magnetic seal member.

9. A developer assembly comprising:
a housing configured to accommodate a roller, configured to accommodate a toner, and configured to accommodate at least one magnetic seal member, wherein the at least one magnetic member is configured to minimize leakage of the toner between the roller and the housing; and
at least one non-magnetic seal member configured to minimize leakage of the toner between the housing and the roller.
